(19) United States
(12) Patent Application Publication
(10) Pub. No.: US 2023/0150044 A1
(43) Pub. Date: May 18, 2023

(54) GUIDE DRESSER, CUTTER HEADS AND METHODS OF USE THEREOF

(71) Applicant: Internal Machinery Solutions Ltd., West Kelowna (CA)

(72) Inventors: Gary Stroud, West Kelowna (CA); Vincent Bergeron, Prince George (CA)

(21) Appl. No.: 17/983,433

(22) Filed: Nov. 9, 2022

Related U.S. Application Data
(63) Continuation-in-part of application No. 17/748,278, filed on May 19, 2022.
Application No. 17/748,278 is a continuation-in-part of application No. 17/528,804, filed on Nov. 17, 2021.

(30) Foreign Application Priority Data
Nov. 19, 2021 (CA) 3139420
May 19, 2022 (CA) 3159644

(51) Int. Cl. B23C 9/00

(52) U.S. Cl. CPC B23C 9/00

(57) ABSTRACT

A guide dresser for milling a saw guide is disclosed herein. The guide dresser includes a guide mount assembly for adjustably moving a saw guide between an upper and lower position and first and second cutter assemblies that are slidably mounted on a rail or slide system so as to be adjustable, in operation, between an open position and a closed position. Cutter heads and methods for milling a saw guide are also disclosed.

### CROSS-REFERENCE TO RELATED APPLICATIONS

This is a continuation-in-part application that claims priority to and benefit of U.S. patent application Ser. No. 17/748,278 filed on May 19, 2022, which is a continuation-in-part application of U.S. patent application Ser. No. 17/528,804 filed on Nov. 17, 2021. This application also claims priority to and benefit of Canadian Patent Application Serial No. 3,139,420 filed on Nov. 19, 2021, and Canadian Patent Application Serial No. 3,159,644 filed on May 19, 2022. Each of these applications are incorporated by reference herein in their entirety.

### TECHNICAL FIELD

The present disclosure generally relates to a guide dresser, cutter heads and methods of use thereof, and more particularly to guide dressers having movable cutter assemblies and a guide mount for adjustably moving a saw guide between upper and lower positions for milling the saw guide.

### BACKGROUND

Production of lumber from raw logs typically involves a first step, called primary breakdown, which involves recovering an elongated square center from a log using head rig equipment. Head rigs generally include a large stationary circular saw or a band saw and a travelling carriage. The travelling carriage rotationally transports a log back and forth through the head rig to remove a series of rounded slabs from outer edges of the log thereby producing the squared center of the log, which is commonly called a “cant”. In some processes, cants are produced with two squared-off opposing sides. Primary breakdown typically produces two-sided and four-sided cants, rounded edge slabs, and sometimes, large boards.

The cants, slabs and boards produced during primary breakdown are further processed during secondary breakdown processes whereby large rectangular side flitches having two opposing parallel sides, are cut from the sides of cants with band saws or circular saws. Flitches are then typically broken down into functional lumber with equipment having multiple parallel circular saw blades mounted onto a fixed driven arbor, commonly known as circular gang saws. The processing step for producing flitches from cants is known as “reducing” while production of functional lumber from flitches includes multiple steps referred to as “edging” and “re-sawing”. High volume throughput systems often combine the reducing and edging steps into one piece of equipment operating under high saw speeds to enable rapid cutting of wood against high pressures forced by rapid throughput of cants and flitches.

Pressing forces applied by high volume throughput of flitches and lumber pieces against circular gang saws often cause undesired lateral movements and vibrations of individual saw blades resulting in deterioration in blade stability and reduced dimensional accuracy in the final finished lumber pieces. It is common practice to provide saw guides interposed between individual blades to maintain their spacing and to minimize the extent of vibration that may occur. The saw guides are securely fixed into place between the individual circular blades by engagement with equipment frame rails or other support elements to provide stability to the saw blades prior to commencing operations.

Accurate saw guides improve the performance of the saws (e.g., gang saws) in the production of lumber. In this regard, guide dressers have been developed to mill and machine saw guides to improve and maintain their longevity and accuracy. However, existing guide dressers and cutter heads are not accurate enough to maintain saw guides within desired tolerances. Also, existing guide dressers and cutters are difficult to set properly and require significant manual operation.

A need therefore exists for an improved guide dresser and cutter heads that exhibit ease of use and a high degree of accuracy in milling and machining saw guides.

### SUMMARY

The present disclosure provides guide dressers, cutter heads and methods for milling or machining a saw guide. The present disclosure recognizes that there are problems in the current existing guide dresser technologies in respect of the apparatus, cutter heads and methods, and provides an improved guide dresser and cutter heads.

An advantage of the present disclosure is the provision of guide dressers and components thereof (e.g., cutter assemblies, cutter heads, guide mount assemblies, etc.) having improved characteristics over existing technologies, tools, processes and systems.

In an embodiment, the present disclosure relates to a guide dresser for milling a saw guide, the guide dresser including: a rail or slide system; a first cutter assembly slidably mounted on the rail or slide system, the first cutter assembly having a first rotatable cutter head; a second cutter assembly slidably mounted on the rail or slide system, the second cutter assembly having a second rotatable cutter head; a guide mount assembly for receiving and adjustably moving a saw guide between an upper position and a lower position, the upper position being above the first and second rotatable cutter heads and the lower position being between the first and second rotatable cutter heads, the guide dresser being adjustable between an open position and a closed position by slidable movement of the first cutter assembly, the second cutter assembly, or both, wherein: when in the open position, both the first cutter assembly and the second cutter assembly are positioned away from the guide mount assembly on the rail system, and when in the closed position, both the first cutter assembly and the second cutter assembly are positioned proximal to the guide mount assembly on the rail system, such that both the first and second rotatable cutter heads are capable of contacting the saw guide when it is received on the guide mount assembly and is in or is moved to the lower position.

In an embodiment of the guide dresser herein, the guide mount assembly includes a mount apparatus and a saw guide rail or slide assembly interconnected to the mount apparatus and configured for receiving the saw guide.

In an embodiment of the guide dresser herein, the saw guide rail or slide assembly includes a saw guide carriage slidably mounted thereon for receiving the saw guide.

In an embodiment of the guide dresser herein, the saw guide rail or slide assembly includes a servo motor-controlled ball screw for adjustably moving the saw guide along the saw guide rail or slide assembly.

In an embodiment of the guide dresser herein, the saw guide rail or slide assembly includes a proximity switch for detecting when the saw guide is in the upper position. In an embodiment, detection of the saw guide in the upper position activates the slidable movement of the first cutter assembly and the second cutter assembly towards each other on the rail or slide system.

In an embodiment of the guide dresser herein, the saw guide rail or slide assembly is aligned for slidable movement of the saw guide between the upper position and the lower position along a fixed non-horizontal axis. In an embodiment, the fixed non-horizontal axis is parallel to a vertical plane defined by a horizontal axis along which slidable movement of the first and second cutter assemblies occurs. In another embodiment, the fixed non-horizontal axis is tilted between about 1° and about 45° degrees from parallel to a vertical plane defined by a horizontal axis along which slidable movement of the first and second cutter assemblies occurs

In an embodiment of the guide dresser herein, each of the upper position and lower position of the saw guide are between the first cutter assembly and the second cutter assembly.

In an embodiment of the guide dresser herein, one or both of movement between the open position and the closed position and movement between the upper position and the lower position is independently, in whole or in part, an automatic operation.

In an embodiment, the guide dresser disclosed herein further includes one or more laser range finders positioned and aligned to take a measurement of the saw guide when the saw guide is positioned on the guide mount assembly, wherein the automatic operation is based on results of the measurement of the one or more laser range finders.

In an embodiment of the guide dresser herein, each of the first cutter assembly and the second cutter assembly include a pivot component for independently adjusting alignment of the first rotatable cutter head and the second rotatable cutter head. In an embodiment, when in operation if the vertical positioning of the saw guide is skewed from a vertical direction, the pivot component aligns the first and second rotatable cutter heads.

In an embodiment of the guide dresser herein, the rail or slide system includes a single continuous rail or slide component having both the first cutter assembly and the second cutter assembly slidably mounted thereon.

In an embodiment of the guide dresser herein, the rail or slide system includes: a first rail or slide apparatus having the first cutter assembly slidably mounted thereon; and a second rail or slide apparatus having the second cutter assembly slidably mounted thereon.

In an embodiment of the guide dresser herein, in operation: the saw guide is received onto the guide mount assembly in the lower position when the first and second cutter assemblies are in the open position; the saw guide is moved to the upper position, thereby activating the first and second cutter assemblies to the closed position; and the saw guide is moved downward towards the lower position once the first and second cutter assemblies are in the closed position, thereby milling the saw guide.

In an embodiment, the present disclosure relates to a method for milling a saw guide, the method including: (a) providing a saw guide to a guide mount assembly of a guide dresser; (b) moving the saw guide to an upper position, the upper position being above a first rotatable cutter head of a first cutter assembly and a second rotatable cutter head of a second cutter assembly; (c) moving the first cutter assembly and the second cutter assembly towards each other on a rail or slide system from an open position to a closed position; (d) moving the saw guide down to a lower position between the first and second rotatable cutter heads in the closed position, thereby causing the first and second rotatable cutter heads to engage the saw guide from opposing sides; and (e) milling or machining the saw guide as it is in or passes to the lower position.

In an embodiment of the methods herein, any one or more of steps (b) to (e) is an automated process. In an embodiment, the automated process includes programmable CNC controls.

Other aspects and embodiments of the disclosure are evident in view of the detailed description provided herein.

### BRIEF DESCRIPTION OF THE DRAWINGS

Further advantages, permutations and combinations of the invention will now appear from the above and from the following detailed description of the various particular embodiments of the invention taken together with the accompanying drawings, each of which are intended to be non-limiting, in which:

FIG. 1 is a perspective view of a guide dresser according to some embodiments of the present disclosure, showing the guide dresser in an open position and the saw guide in a lower position;

FIG. 2 is a perspective view of a guide dresser according to some embodiments of the present disclosure, showing the guide dresser in a closed position and the saw guide in an upper position;

FIG. 3 is a perspective view of a guide dresser according to some embodiments of the present disclosure, showing the guide dresser in a closed position and the saw guide in a lower position;

FIG. 4 is a front view of an exemplary saw guide rail or slide assembly according to some embodiments of the present disclosure;

FIG. 5 is a side view of the saw guide rail or slide assembly of FIG. 4 according to some embodiments of the present disclosure;

FIG. 6 is a perspective view of a front side of an exemplary cutter head according to some embodiments of the present disclosure shaped as a circular disc and having knives contained within knife retention apparatuses;

FIG. 7 is a top view of the front side of the cutter head of FIG. 6 according to some embodiments of the present disclosure;

FIG. 8 is a perspective view of a back side of the cutter head of FIG. 6 according to some embodiments of the present disclosure;

FIG. 9 is a side view of the cutter head of FIG. 6 according to some embodiments of the present disclosure;

FIG. 10 is an extracted view of the knife retention apparatus shown as a component of the cutter head of FIG. 6 according to some embodiments of the present disclosure;

FIG. 11 is a perspective view of a front side of another exemplary cutter head according to some embodiments of the present disclosure shaped as a circular disc and having carbide inserts as the milling implement;

FIG. 12 is a top view of the front side of the cutter head of FIG. 11 according to some embodiments of the present disclosure;

FIG. 13 is a side view of the cutter head of FIG. 11 according to some embodiments of the present disclosure;

FIG. 14 is a front view of a cutter assembly according to some embodiments of the present disclosure.

FIG. 15 is a cross-sectional view along the A-A line shown in FIG. 14 according to some embodiments of the present disclosure;

FIG. 16 is an exploded perspective view of an exemplary pivot component for use in association with the cutter assembly according to some embodiments of the present disclosure;

FIG. 17 is an exploded perspective view of a two-part pivotable block component for use in association the cutter assembly according to some embodiments of the present disclosure;

FIG. 18 is a perspective view of an automated guide dresser according to some embodiments of the present disclosure; and

FIG. 19 is a flowchart showing the steps of a method for automated milling of a saw guide according to some embodiments of the present disclosure.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the suitable methods and materials are described below.

The embodiments of the present disclosure pertain to guide dressers, cutter heads, guide mount assemblies and methods having improved functionality for milling and machining saw guides. Guide dressers of the present disclosure have guide mount assemblies for adjustably moving a saw guide between an upper and lower position and moveable cutter assemblies for engaging and disengaging the saw guide with rotatable cutter heads. In select embodiments, cutter assemblies are slidably mounted on a rail or slide system so as to be adjustable between an open position and a closed position. In select embodiments, a saw guide is slidably mounted on a saw guide rail or slide assembly so as to be adjustable between an upper position and a lower position. Cutter heads which may be used with the guide dressers of the present disclosure include conventional cutter heads, as well as the cutter heads of the present disclosure having unique features and configurations for improved milling of a saw guide.

The present disclosure provides a number of advantages over existing technologies. For example, existing guide dressers are not accurate enough and are difficult to set properly. This is due to a number of factors, including for example the saw guide being fed into the cutters in conventional configurations and orientations. Moreover, existing cutter heads are often set in position by hand and are rarely capable of milling a saw guide to desired or even acceptable tolerances. Further, horizontal movement of saw guides into cutter heads can cause issues of inaccurate milling and potentially even harmonic resonance, sagging of heavier saw guides, and inaccurate alignment between the cutter heads and the saw guide.

An advantage of the present disclosure is the provision of guide dressers having improved characteristics over existing technologies, in particular using a configuration by which a saw guide is moved from an upper position to a lower position into operational cutter heads. In embodiments of the guide dressers of the present disclosure, cutter assemblies are moved to a closed position and the saw guide is fed into the cutter heads by movement from an upper position to a lower position on an adjustable guide mount assembly. In certain embodiments, the process is automated. For example, in certain embodiments of the present disclosure one or more laser range finders may be employed for automated movement and/or programming of the cutter assemblies and/or the saw guide on the guide mount assemblies. In some embodiments, the saw guide is fed into the cutter heads of opposing cutter assemblies using programmable computer numerical control (CNC) programming.

In some embodiments, the present disclosure relates to a guide dresser for milling a saw guide, the guide dresser including: a rail or slide system; a first cutter assembly slidably mounted on the rail or slide system, the first cutter assembly having a first rotatable cutter head; a second cutter assembly slidably mounted on the rail or slide system, the second cutter assembly having a second rotatable cutter head; a guide mount assembly for receiving and adjustably moving a saw guide between an upper position and a lower position, the upper position being above the first and second rotatable cutter heads and the lower position being between the first and second rotatable cutter heads, the guide dresser being adjustable between an open position and a closed position by slidable movement of the first cutter assembly, the second cutter assembly, or both, wherein: when in the open position, both the first cutter assembly and the second cutter assembly are positioned away from the guide mount assembly on the rail system, and when in the closed position, both the first cutter assembly and the second cutter assembly are positioned proximal to the guide mount assembly on the rail system, such that both the first and second rotatable cutter heads are capable of contacting the saw guide when it is received on the guide mount assembly and is in or is moved to the lower position.

In some embodiments, the guide dresser as described herein may further include one or more laser range finders positioned and aligned to take a measurement of the saw guide when the saw guide is positioned on the guide mount assembly. In such embodiments, movement of the cutter assemblies and/or the saw guide on the guide mount assembly may be automated such that the slidable movement of the cutter assemblies between the open position and the closed position and/or movement of the saw guide between the upper and lower position is in whole or in part an automatic operation based on results of the measurement of the one or more laser range finders. In an embodiment, the automated process includes programmable CNC controls.

It will be appreciated that while the exemplary embodiments of the guide dresser as shown in the figures herein have the rail or slide system for the cutter assemblies in a horizontal orientation generally parallel to the ground or floor, other configurations are contemplated, such as for example where the slide or rail system is tilted or in an up/down configuration. The rail or slide system also need not provide slidable movement in a linear direction but may also provide a curved path of movement or any other configuration. Likewise, while the exemplary embodiments of the guide dresser as shown in the figures herein have a guide mount assembly with a saw guide slide and rail assembly that moves the saw guide in a vertical direction generally perpendicular to the ground or floor, other configurations are contemplated, such as for example where the saw guide slide or rail system is tilted in a direction slightly askew from perpendicular.

Reference will now be made in detail to exemplary embodiments of the disclosure, wherein numerals refer to like components, examples of which are illustrated in the accompanying drawings that further show exemplary embodiments, without limitation.

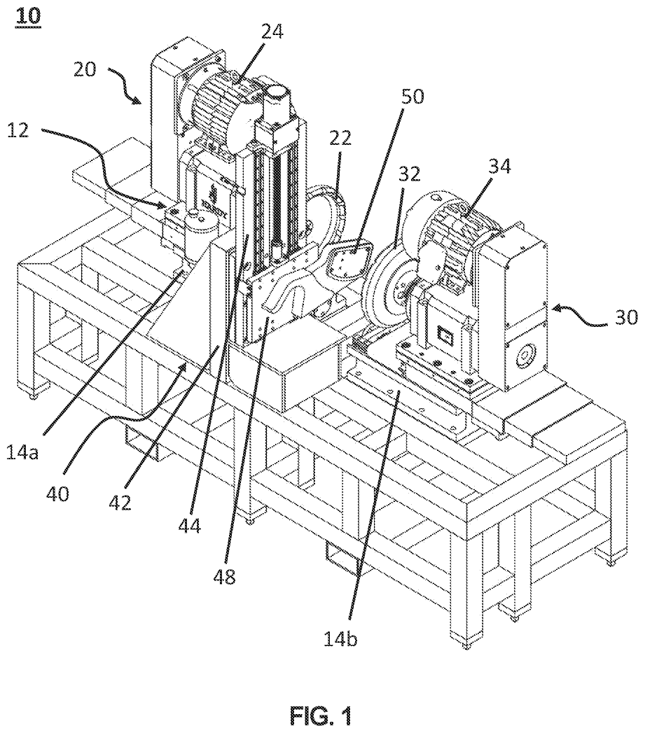

FIGS. 1, 2, and 3 illustrate perspective views of an exemplary embodiment of a guide dresser 10 according to the present disclosure. The guide dresser 10 as shown in FIGS. 1, 2, and 3 includes a rail or slide system 12, a first cutter assembly 20 having a first rotatable cutter head 22 and a motor 24, a second cutter assembly 30 having a second rotatable cutter head 32 and a motor 34, and a guide mount assembly 40. The guide mount assembly 40 is capable of receiving a saw guide 50.

In the guide dressers of the present disclosure, the first cutter assembly 20 and the second cutter assembly 30 are slidably mounted on the rail or slide system 12. By “rail or slide system”, it is meant to refer to any arrangement of components that allow for movement of the first and second cutter assemblies (20, 30). The rail or slide system 12 may, for example and without limitation, include wheels, tracks, trolleys, grooves, slides, bearings, or any combination thereof. In an embodiment, the rail or slide system 12 is a track-and-trolley system. In an embodiment, the rail or slide system 12 includes a ball screw and linear bearings. By “slidably mounted”, it is meant to refer to any type of movement whereby the cutter assembly (20, 30) is moved from one position to another while attached to the rail or slide system 12, or components thereof. The first cutter assembly 20 and the second cutter assembly 30 may be mounted on, or attached to, the rail or slide system 12 by any suitable means.

In some embodiments of the present disclosure, the rail or slide system 12 includes a single continuous rail or slide component having both the first cutter assembly 20 and the second cutter assembly 30 slidably mounted thereon. For example, the rail or slide system 12 may extend a length that traverses past (e.g., in front of) the guide mount assembly 40, with the first cutter assembly 20 mounted on the rail or slide system 12 on one side of the guide mount assembly 40, and the second cutter assembly 30 mounted on the rail or slide system 12 on the other side of the guide mount assembly 40.

In other embodiments, the rail or slide system 12 includes a separate apparatus or structure for each of the first cutter assembly 20 and the second cutter assembly 30. For example, as shown in FIG. 1, each of the first cutter assembly 20 and the second cutter assembly 30 may be mounted on its own rail or slide apparatus (14a, 14b).

The rail or slide system 12 may be configured for linear movement of each cutter assembly (20, 30), meaning that the cutter assemblies (20, 30) are moved along a straight path in the rail or slide system 12. Alternatively, the rail or slide system 12 may have a configuration that provides for non-linear movement of the cutter assemblies (20, 30). For example, the cutter assemblies (20, 30) may travel along a curved or arched path to approach the position of the guide mount assembly 40.

Irrespective of the configuration of the rail or slide system 12, movement of the cutter assemblies (20, 30) may be manual, automated, or any combination thereof. In an embodiment, the position of each cutter assembly (20, 30) on the rail or slide system 12 is controlled with programmable controller, such as a programmable logic controller (PLC) and/or computer numerical control (CNC) programming. In an embodiment, the rail or slide system 12 includes its own independent motor to drive movement of each cutter assembly (20, 30) on the rail or slide system 12. The motor may, for example, be a servo motor. In an embodiment, the rail or slide system 12 includes servo motor-controlled ball screw and linear bearings for programmable and repeatable positioning of each cutter assembly (20, 30). The rpm and spherical alignment of the cutter heads (22, 32) may also be similarly controlled by manual processes, automated processes, or a combination thereof.

Referring again to FIGS. 1, 2, and 3, the first cutter assembly 20 and the second cutter assembly 30 each have respective rotatable cutter heads (22, 32). As used herein, the term “rotatable cutter head” is intended to refer to the cutting apparatus for engaging and milling a saw guide 50. The rotatable cutter head is, for example, mounted on a spindle to which rotational movement is applied. The rotational movement may be from any suitable source. In an embodiment, each cutter assembly (20, 30) has a motor (24, 34) to drive the rotational movement. The motor (24, 34) may, for example, be a belt drive motor which supplies rotational movement to a belt that is connected to both the motor and a spindle connect to the cutter heads (22, 32). In some embodiments, each cutter assembly (20, 30) has its own motor (24, 34) and drive system for providing rotational movement to the cutter heads (22, 32). In other embodiments, a single motor may be used to provide rotational movement to the cutter heads (22, 32) on both cutter assemblies (20, 30). Other arrangements and configurations to provide rotational movement to the cutter heads (22, 32) will be well-appreciated by the skilled person.

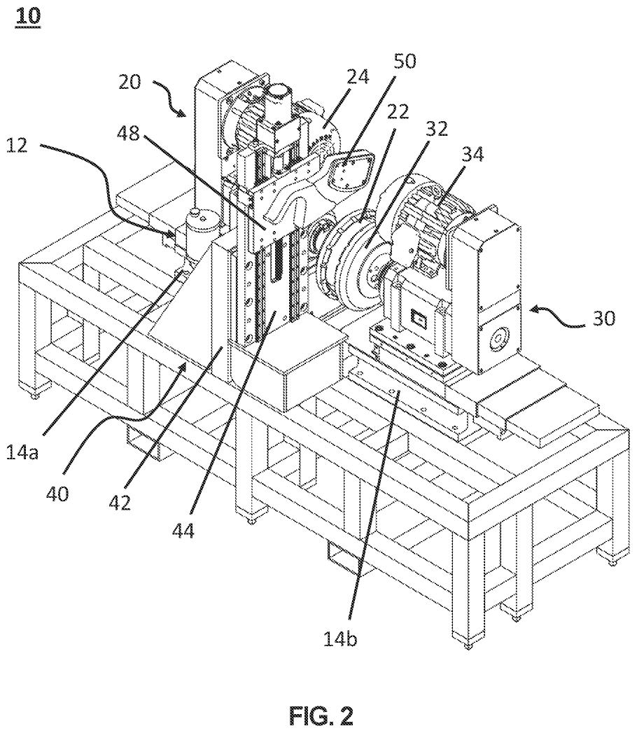

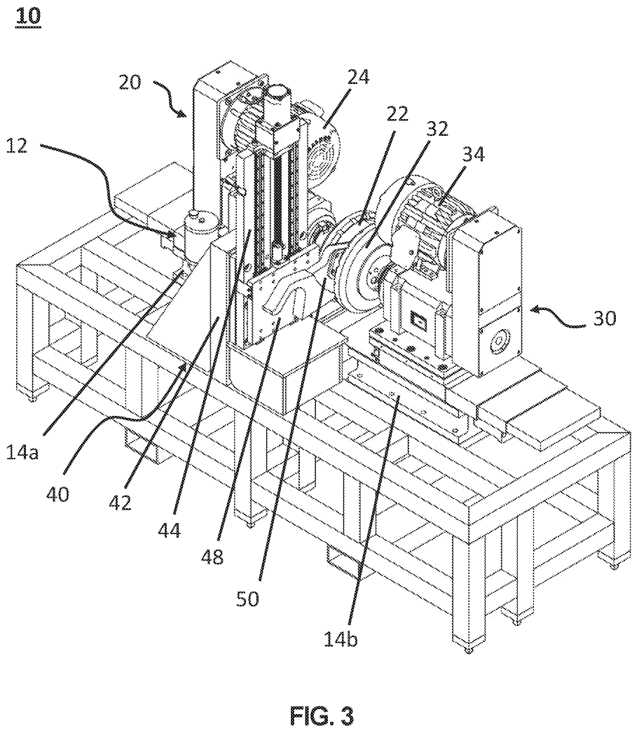

As further shown in FIGS. 1, 2, and 3, the guide dresser 10 of the present disclosure includes a guide mount assembly 40. The guide mount assembly 40 is a component of the guide dresser 10 capable of mounting a saw guide 50 thereto and adjustably moving the saw guide 50 between an upper position (e.g., as in FIG. 2) and a lower position (e.g., as in FIGS. 1 and 3).

As used herein, the expression “upper position” is intended to refer to a configuration of the guide mount assembly 40 whereby the saw guide 50 is positioned above both the first and second rotatable cutter heads (22, 32). By “above” the first and second rotatable cutter heads (22, 32), it is meant that the saw guide 50 is positioned higher in a vertical plane than the tops of the first and second rotatable cutter heads (22, 32). For the saw guide 50 to be above the first and second rotatable cutter heads (22, 32), it does not require the saw guide 50 to be directly over the first and second rotatable cutter heads (22, 32). For example, when the first and second cutter assemblies (20, 30) are in the open position such as in FIG. 1, if the saw guide 50 were in the upper position it would be above the first and second rotatable cutter heads (22, 32), but not in the space over them. Thus, in the present disclosure being above the first and second rotatable cutter heads (22, 32) is not to be equated with being over the first and second rotatable cutter heads (22, 32), although in some embodiments the saw guide 50 may also be over one or both of the first and second rotatable cutter heads (22, 32).

As used herein, the expression “lower position” is intended to refer to a configuration of the guide mount assembly 40 whereby the saw guide 50 is positioned between the first rotatable cutter head 22 and the second rotatable cutter head 32. In this lower position, if the first and second cutter assemblies (20, 30) are in the closed position they would be capable of engaging and milling opposing sides of the saw guide 50, such as shown in FIG. 3.

In operation, the guide dresser 10 of the present disclosure adjustably moves the saw guide 50 between the upper position and lower position to mill the saw guide 50. For example and without limitation, the saw guide 50 may be mounted onto the saw guide assembly 40 in the lower position while the first and second cutter assemblies (20, 30) are in the open position (FIG. 1); the saw guide 50 may be moved to the upper position while the first and second cutter assemblies (20, 30) are moved to the closed position (FIG. 2); and the saw guide 50 may moved back towards the lower position while the first and second cutter assemblies (20, 30) remain in the closed position, with or without adjustment, to mill the saw guide (FIG. 3).

The guide mount assembly 40 may be of any suitable configuration to move the saw guide 50 from the upper position to the lower position. Referring to FIGS. 1-5, an exemplary embodiment is shown. The guide mount assembly 40 is configured for removable attachment of the saw guide 50 and is of sufficient strength to withstand the forces imparted by cutter heads (22, 32).

In an embodiment, the guide mount assembly 40 includes a mount apparatus 42 and a saw guide rail or slide assembly 44. By “saw guide rail or slide assembly”, it is meant to refer to any arrangement of components that allow for movement of the saw guide 50 between the upper and lower positions. The saw guide rail or slide assembly 44 may, for example and without limitation, include wheels, tracks, trolleys, grooves, slides, bearings, or any combination thereof. In an embodiment, the saw guide rail or slide assembly 44 is a track-and-trolley system. In an embodiment, the saw guide rail or slide assembly 44 includes a ball screw and linear bearings.

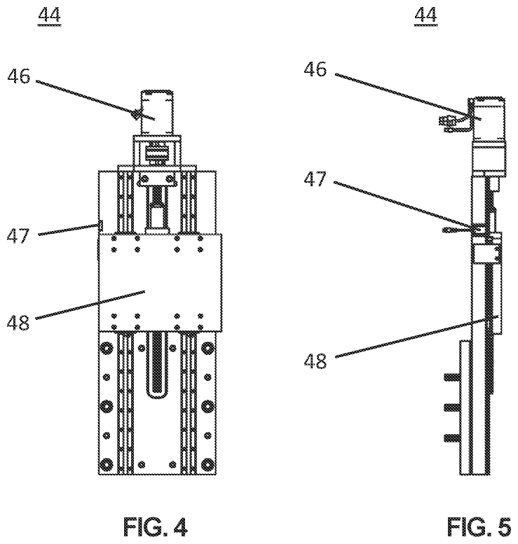

As shown in FIGS. 1, 2, and 3, the saw guide rail or slide assembly 44 may be interconnected to the mount apparatus 42 and configured for receiving the saw guide. For example, the saw guide rail or slide assembly 44 may include a saw guide carriage 48 slidably mounted thereon for receiving the saw guide 50. FIGS. 4 and 5 show the saw guide rail or slide assembly 44 in different views and disconnected from the mount apparatus 42. At the bottom of FIG. 5 can be seen bolts used to interconnect the saw guide rail or slide assembly 44 to the mount apparatus 42. In this embodiment, the saw guide carriage 48 is a metal plate onto which the saw guide 50 may be mounted. The backside of the saw guide carriage 48 slidably interacts with other components of the saw guide rail or slide assembly 44 to allow for adjustable movement of the saw guide 50 between the upper and lower position. In an embodiment, the saw guide rail or slide assembly 44 includes an independent motor 46 for adjustably moving the saw guide 50 along the saw guide rail or slide assembly 44. The motor 46 may, for example, be a servo motor. In this embodiment, the saw guide rail or slide assembly 44 may include servo motor-controlled ball screw and linear bearings for programmable and repeatable positioning of the saw guide.

As shown in FIGS. 4 and 5, the saw guide rail or slide assembly 44 may include a proximity switch 46. In an embodiment, the proximity switch 47 is for detecting when the saw guide 50 is in the upper position. In an embodiment, detection of saw guide carriage 48 by the proximity switch 46 activates movement of the first and second cutter assemblies (20, 30) from the open position to the closed position. Other arrangements and configurations to move the saw guide 50 will be well-appreciated by the skilled person.

As mentioned above, the guide mount assembly 40 may be of any suitable configuration to move the saw guide 50 from the upper position to the lower position. In an exemplary embodiment, the saw guide rail or slide assembly 44 is aligned for slidable movement of the saw guide 50 between the upper position and the lower position along a fixed non-horizontal axis. By “fixed non-horizontal axis”, it is meant that the saw guide 50 is moved in a straight path between the upper position and lower position, and the straight path is not along a horizontal plane.

For example, in one embodiment and as shown in FIGS. 1-5, the fixed non-horizontal axis may be a path that is parallel to a vertical plane defined by a horizontal axis along which slidable movement of the first and second cutter assemblies (20, 30) occurs. In essence, the saw guide 50 moves along a straight up-and-down vertical path when the first and second cutter assemblies (20, 30) move along a straight side-to-side horizontal path. In such embodiments, each of the upper position and lower position of the saw guide 50 may be between the first cutter assembly 20 and the second cutter assembly 30 since the saw guide 50 moves linearly up and down between them.

In other embodiments, the fixed non-horizontal axis may not be a straight up-and-down path. Rather, in some embodiments, the fixed non-horizontal axis is tilted a certain degree from parallel to a vertical plane defined by a horizontal axis along which slidable movement of the first and second cutter assemblies (20, 30) occurs. In essence, tilted towards the front or back of the guide dresser. By “front”, it means the side on which the guide mount assembly 40 is positioned. By “back”, it means the opposite side to which the guide mount assembly 40 is positioned. By “tilted towards the front”, it means that in the upper position the saw guide 50 is positioned towards the front. By “tilted towards the back”, it means that in the upper position the saw guide 50 is positioned towards the back (e.g., between the cutter assemblies).

In some embodiments, the fixed non-horizontal axis is tilted between about 1° and about 45° towards the front or back of the guide dresser. In some embodiments, the fixed non-horizontal axis is tilted between about 1° and about 15° towards the front or back of the guide dresser. In some embodiments, the fixed non-horizontal axis is tilted between about 1° and about 15° towards the front of the guide dresser. In some embodiments, the fixed non-horizontal axis is tilted about 1°, about 2°, about 3°, about 4°, about 5°, about 6°, about 7°, about 8°, about 9°, about 10°, about 11°, about 12°, about 13°, about 14°, about 15°, about 20°, about 25°, about 30°, about 35°, about 40°, or about 45° towards the front or back of the guide dresser. In some embodiments, the fixed non-horizontal axis is tilted about 1°, about 2°, about 3°, about 4°, about 5°, about 6°, about 7°, about 8°, about 9°, about 10°, about 11°, about 12°, about 13°, about 14°, about 15° towards the front of the guide dresser.

Movement of the saw guide 50 on the guide mount assembly 40 may be configured for linear movement, meaning that the saw guide 50 is moved along a straight path (e.g., the fixed non-horizontal axis). Alternatively, the guide mount assembly 40 may have a configuration that provides for non-linear movement of the saw guide 50. For example, the saw guide 50 may start from the upper position to travel along a curved or arched path to the lower position.

Irrespective of the configuration of the guide mount assembly 40, movement of the saw guide 50 may be manual, automated, or any combination thereof. In an embodiment, the position of the saw guide 50 on the guide mount assembly 40 is controlled with a programmable controller, such as a programmable logic controller (PLC) and/or computer numerical control (CNC) programming. Automated movement and control of the position of the saw guide 50 may, for example, be enabled through certain embodiments of a saw guide rail or slide assembly 44.

The guide mount assembly 40 is in a suitable position on the guide dresser 10 to place the saw guide 50 between the first rotatable cutter head 22 and the second rotatable cutter head 32 in the lower position. By this, it is meant that when the first cutter assembly 20 and second cutter assembly 30 travel to an end of, or position on, the rail or slide system 12 that is proximal to the guide mount assembly 40, the cutter heads (22, 32) are positioned so as to be capable of engaging the saw guide 50 for milling and machining operations when the saw guide 50 is in the lower position. In some embodiments, the guide mount assembly 40 is positioned between the first cutter assembly 20 and second cutter assembly 30, but slightly askew so that the guide mount assembly 40 does not interfere with the ability of the cutter heads (22, 32) to contact the saw guide 50. In some embodiments, the guide mount assembly 40 is positioned to one side of the guide dresser 10 and the guide mount assembly 40 has an extension component that places the saw guide 50 in the lower position between the first rotatable cutter head 20 and the second rotatable cutter head 30.

In operation, the rail or slide system 12 permits movement or travel of the first rotatable cutter head 20 and the second rotatable cutter head 30 towards and away from the guide mount assembly 40 to alternate between an “open position” and a “closed position”. Thus, the guide dresser 10 of the present disclosure is capable of being adjusted between an open position and a closed position.

As used herein, the expression “open position” is intended to refer to a configuration of the guide dresser 10 whereby both the first cutter assembly 20 and second cutter assembly 30 are positioned away from the guide mount assembly 40 on the rail or slide system 12. By “positioned away”, it is meant that the cutter assembly (20, 30) is in a position on the rail or slide system 12 that the cutter head (22, 32) would not be capable of engaging or contacting the saw guide 50 when the saw guide 50 is received by the guide mount assembly 40 and in the lower position. In an embodiment, in the open position both the first cutter assembly 20 and second cutter assembly 30 are positioned as far away from the guide mount assembly 40 as is permitted by the rail or slide system 12. In other embodiments, the first cutter assembly 20 and second cutter assembly 30 may independently be at any distance away from the guide mount assembly 40 along the rail or slide system 12, and each may be at the same or a different distance away from the guide mount assembly 40.

As used herein, the expression “closed position” is intended to refer to a configuration of the guide dresser 10 whereby both the first cutter assembly 20 and second cutter assembly 30 are positioned such that both the first cutter head 22 and second cutter head 32 are capable of contacting the saw guide 50 when it is received within the guide mount assembly 40 and is in the lower position. In the closed position, the guide dresser 10 can operate to mill both sides of the saw guide 50.

In addition to the open position and closed position, it should be understood that the guide dresser 10 disclosed herein is capable of being operated in such a manner that only one of the cutter assemblies (20, 30) is positioned to allow the cutter head (22, 32) to engage or contact the saw guide 50, and thereby mill a single side of the saw guide 50.

In an embodiment, the guide dresser 10 of the present disclosure is fully enclosed within an encasement having a door. In an embodiment, the door is located to provide access to the guide mount assembly 40. For milling a saw guide 50, a user or automated controller need only open the door and install a saw guide 50 on the guide mount assembly 40. Installation of the saw guide 50 on the guide mount assembly 40 is an easy process and is accurately repeatable to provide for reliability in accuracy of milling. In an embodiment, the guide dresser 10 can only be operated when a magnetic door lock is engaged.

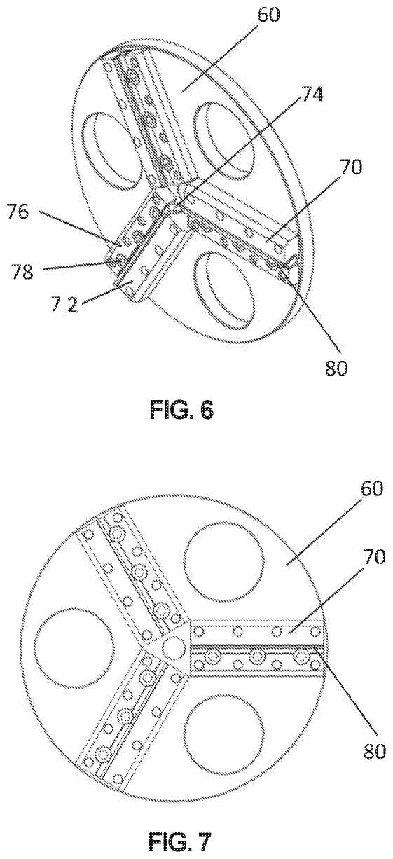

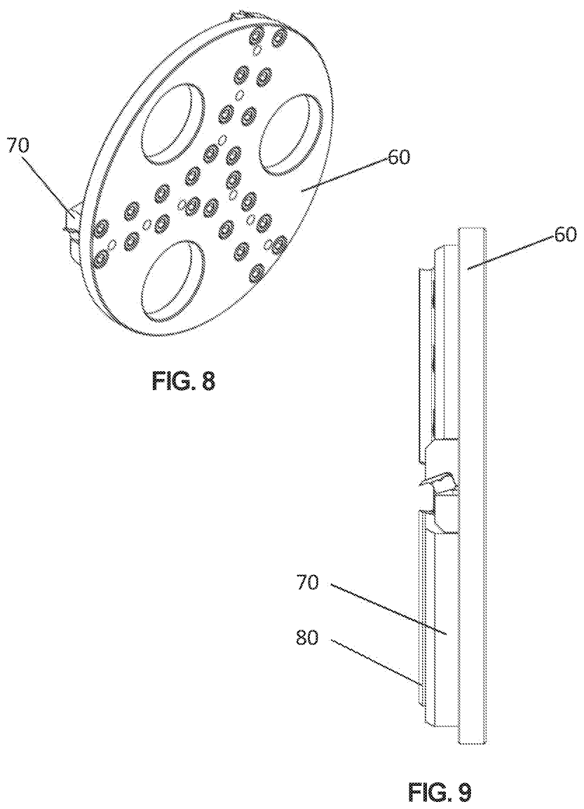

The present disclosure also relates to cutter heads which may be used with the guide dresser 10 described herein. Referring now to FIGS. 6 to 10, each cutter assembly (20, 30) of the present disclosure includes a cutter head (22, 32). An embodiment of a cutter head (22, 32) of the present disclosure is shown in FIGS. 6 to 10. In this embodiment, the cutter head (22, 32) includes a circular disc 60 and one or more removable knife retention apparatuses 70, each of the one or more removable knife retention apparatuses for receiving a knife 80. The circular disc 60 is shaped like a wheel, having a front surface, a back surface and an outer perimeter surface. The circular disc 60 may have apertures traversing from its front surface to back surface. By “front surface” it means the side that performs the milling of the saw guide 50, and the back surface is the opposite side. Each of the knife retention apparatuses 70 can be permanently or removably mounted on the front surface of the circular disc 60.

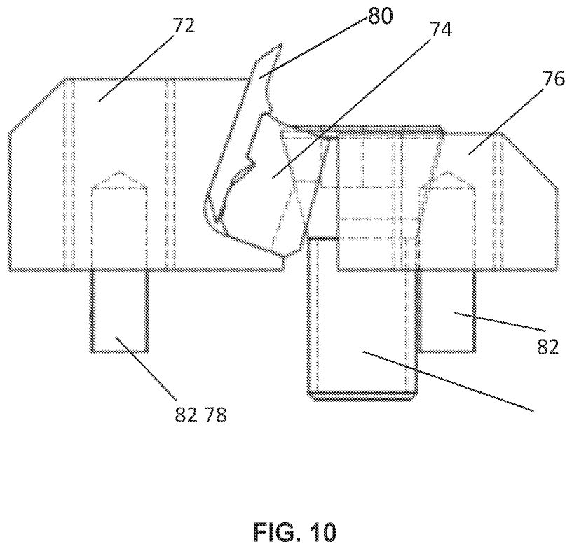

In an embodiment, the knife retention apparatus 70 is a configuration that can be removably mounted to the circular disc 60. An exemplary embodiment is shown in FIG. 10 where the knife retention apparatus 70 includes a knife holder 72, a knife gib 74, a knife clamp 76, and one or more knife gib screws 78. In this configuration, the knife 80 is positioned between the knife holder 72 and the knife gib 74, with the knife gib 74 pressing against the knife 80 by way a force applied from the one of more knife screws 78. The knife clamp 76 is on the opposite side of the knife screws 78 from the knife gib 74 to act as a counterbalance to the force of the knife screws 78, for example by way of opposing notches in the knife gib 74 and knife clamp 76 into which at least a portion of the knife screw 78 is received. In some embodiments, the knife holder 72 and the knife clamp 76 include one or more mounting apertures for receiving a pin 82 protruding from the circular disc 60. In an embodiment, the pins 82 are dowel pins. The mounting apertures and pins 82 provide accuracy and rigidity for the positioning of the knife retention apparatus 70, and therefore the position of the knife 80.

Many adjustments to the configuration of the knife retention apparatus 70 can be made. For example, the knife holder 72 can be manufactured to allow any desired knife angle by adjusting the angle of the wall of the knife holder 72 against which the knife 80 is held. In an embodiment, the angle can be any angle between about 15.0° and about 80.0° relative to the front surface of the circular disc 60. In an embodiment, the angle is between about 45.0° and about 75.0° relative to the front surface of the circular disc 60. As shown in FIG. 6, the knife holder 72, knife gib 74, and knife clamp 76 may be of an elongated shape configured to substantially span a radius of the circular disc 60 when mounted on the circular disc 60. By “elongate shape”, it means a structure that is longer in one direction (e.g., length) than in other directions (e.g., width, height). For example, and without limitation, an elongated shape may be similar to a rectangle in shape. By “substantially span a radius of the circular disc”, it is meant to extend from near the center of the circular disc 60 to near the outer edge of the circular disc 60. This shape and configuration may be preferred for rigidity and accuracy, but other configurations can also be used.

In an embodiment, each knife retention apparatus 70 includes two or more knife screws 78. In an embodiment, each knife retention apparatus 70 includes 2, 3, 4, 5 or more knife screws 78. In an embodiment, each knife retention apparatus 70 includes three knife screws 78.

The cutter head (22, 32) may include any number of the knife retention apparatuses 70 on the circular disc 60. In an embodiment, cutter head (22, 32) includes 2, 3, 4, 5, 6, 7, 8, 9, 10 or more knife retention apparatuses 70 on the circular disc 60. In a particular embodiment, cutter head (22, 32) includes 3, 4 or 5 knife retention apparatuses 70 on the circular disc 60. The components of the knife retention apparatuses 70 may mounted on the circular disc 60 by any suitable means. In an embodiment, the knife retention apparatus 70 is mounted to the circular disc 60 by screws, bolts or other types of fasteners. In operation, each knife retention apparatus 70 would have a knife 80 received therein, with the blade protruding outwards.

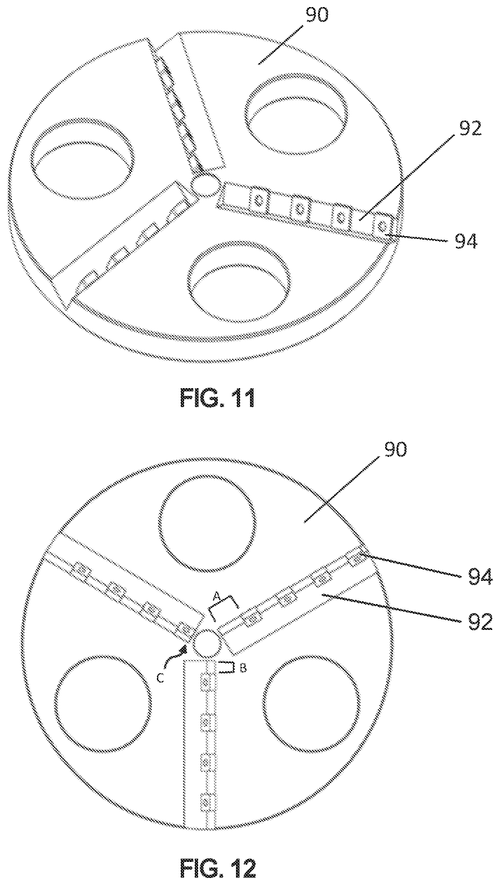

Another exemplary embodiment of a cutter head (22, 32) of the present disclosure is shown in FIGS. 11 to 13. In this embodiment, the cutter head (22, 32) includes a circular disc 90 having grooves 92 on a front face thereof. By “front surface” it is again meant the side that performs the milling of the saw guide 50. Similar to circular disc 60, circular disc 90 having grooves 92 may have apertures traversing from its front surface to back surface. By “grooves”, it is meant an indent or depression in the surface.

The grooves 92 may be of any suitable shape to receive two or more cutting implements 94. In an embodiment, each groove 92 is an elongated shape configured to substantially span a radius of the circular disc. By “elongate shape”, it means an indent or depression that is longer in one direction (e.g., length) than in other directions (e.g., width, height). For example, and without limitation, an elongated shape of groove 92 may be a channel, in particular a linear channel. By “substantially span a radius of the circular disc”, it is meant to extend from near the center of the circular disc 60 to near or at the outer edge of the circular disc 60. As shown in FIG. 11, in an embodiment groove 92 extends from near the center of the circular disc 60 to the outer perimeter, with a portion of the outer perimeter surface also removed to form the groove 92. In other embodiments, the groove 92 may not extend into the outer perimeter surface, but rather may end just before the outer edge of the circular disc 92.

The cutter head (22, 32) may include any number of grooves. In an embodiment, the cutter head (22, 32) has at least two grooves 92. In an embodiment, the cutter head (22, 32) has 2, 3, 4, 5, 6, 7, 8, 9, 10, or more grooves 92. In an embodiment, the cutter head (22, 32) has 3, 4 or 5 grooves 92. In an embodiment, the cutter head (22, 32) has 3, 4 or 5 grooves 92 and each of the grooves 92 is an elongate shape configured to substantially span a radius of the circular disc. In an embodiment, the cutter head (22, 32) has three grooves 92 and each of the grooves 92 is an elongate shape configured to substantially span a radius of the circular disc.

The cutting implements 94 may be positioned at any suitable position within the groove 92 to expose a cutting surface for milling a saw guide 50, and there may be any suitable number of cutting implements 94 within each groove 92. In an embodiment, each groove 92 has at least two cutting implements 94 that are separate from each other. In an embodiment, each groove 92 independently has 2, 3, 4, 5, 6, 7, 8, 9, 10, or more cutting implements 94 that are separate from each other. In an embodiment, each groove 92 independently has 3, 4 or 5 cutting implements 94 that are separate from each other. Each groove 92 may have the same or a different number of cutting implements 94. In an embodiment, each groove 92 has four cutting implements 94 that are separate from each other.

In an embodiment, when two or more of the cutting implements 94 are positioned within a respective groove 92, the two or more cutting implements 94 are substantially equally spaced from each other along a radially extending wall within each groove 92. By “substantially equally spaced apart” it means that the distance or spacing between each of the cutting implements 94 along a length of the groove 92 is about the same. An example of this is shown in FIG. 11 where cutting implements 94 that are of a square shape are each spaced about the same distance from each other within groove 92. In other embodiments, the cutting implements 94 may not be equally spaced apart within the groove 94.

In an embodiment, when there are two or more grooves 92, the cutting implements 94 in each groove 92 may be radially offset from the cutting implements in another groove 92. For example, the cutting implements 94 in each groove 92 may be offset from the center of the circular disc 90 by a different distance. An example of this is shown in FIG. 12 where the cutting implement 94 closest to the center of the disc in each groove is positioned a different distance away from the center (as shown by A, B and C). By spacing identical cutting implements 94 at different distances from the center of the circular disc 90, and then having the cutting implements 94 equally spaced apart within the groove 92, this causes each cutting implement 94 to follow a different circular path upon rotation of the cutter head (22, 32). Thus, upon circular rotation, the two or more cutting implements 94 in each groove cuts a different circular area than the two or more cutting implements 94 in the other grooves. By “circular area” it is meant to refer to the area in the circular path of all of the cutting implements 94 within a respective groove. Since the cutting implements 94 are spaced apart, there would be alternating ‘cut’ and ‘cut’ paths for each groove 92. In an embodiment, the cutting implements 94 in each groove can be arranged such the different circular area cut by the cutting implements 94 in each groove overlaps with a portion of the different circular area cut by the cutting implements 94 in at least one of the other grooves. This can be configured for any number of grooves 92 and any number of cutting implements 94 within each groove 92.

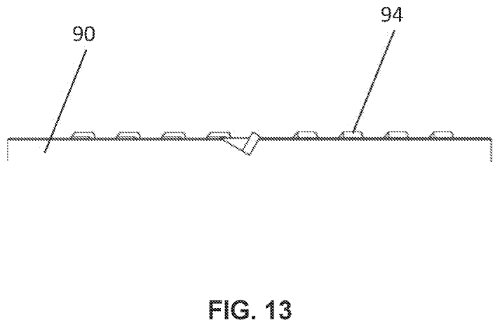

The cutting implements 94 may be any suitable cutting device for milling a saw guide 50. In an embodiment, the cutting implement 94 is a knife. In an embodiment, the cutting implements 94 are included of carbide. In an embodiment, the cutting implements 94 are approximately square or rectangle pieces of carbide. The cutting implements 94 may be secured to the circular disc 90 in any suitable manner. In an embodiment, the cutting implements 94 are secured to the circular disc 90 a screw or a clamp. In operation, each cutting implement 94 protrudes outwards from the grooves 92 by a sufficient amount to provide for milling of a saw guide 50 (see exemplary in FIG. 13). The angle of the wall of the groove may be adjusted to change the angle by which the cutting implement 94 contacts the saw guide 50.

In an embodiment, the guide dresser 10 as disclosed herein includes the cutter heads (22, 32) as disclosed herein. Combined usage of the guide dresser 10 and cutter heads (22, 32) of the present disclosure is advantageous in providing more accurate and reliable milling of saw guides 50.

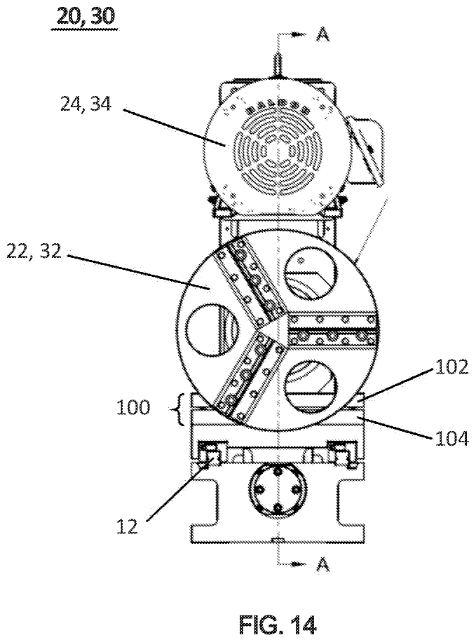

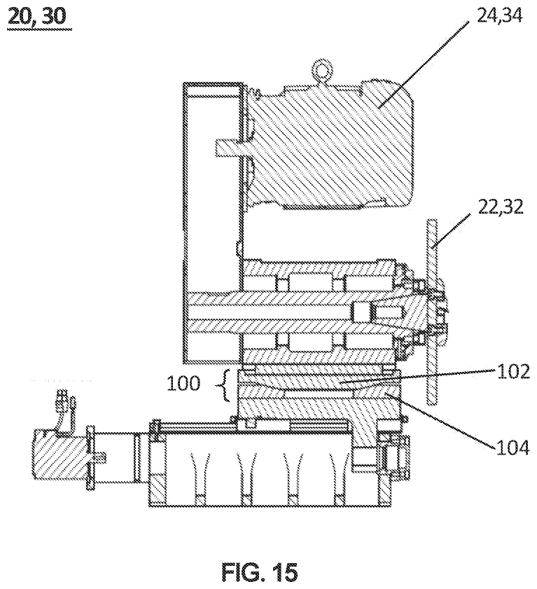

Referring now to FIGS. 14 and 15, in some embodiments one or both of the first cutter assembly 20 and the second head cutter assembly 30 may include a pivot component 100 for adjusting alignment of the respective cutter head (22, 32) in relation to a saw guide 50 to be milled. The pivot component 100 may be located on the underside of the cutter assembly (20, 30) and may be integral thereto or a separate component attached in some manner to the cutter assembly (20, 30). When equipped, the pivot component 100 is capable of allowing each cutter assembly to tilt independently in any direction to thereby adjust the alignment of the cutter heads (22, 32) in relation to a saw guide. Titling of the cutter heads (22, 32) can provide for more accurate and precise milling and machining of the saw guide. Since the cutter heads (22, 32) can tilt in any direction by way of the pivot component 100, the pivot component 100 provides a means of spherical adjustment.

In an embodiment, the pivot component 100 of the cutter assembly (20, 30) allows for adjusting vertical alignment of the respective cutter head (22, 32). By “vertical alignment” it is meant to refer to the vertical plane of the cutter head (22, 32), which may be perfectly perpendicular to the plane of travel of the cutter assembly (20, 30) on the rail or slide system 12, or may be slightly offset. In an embodiment, the vertical alignment is perfectly perpendicular to the plane of travel of the cutter assembly (20, 30). In an embodiment, the vertical alignment a straight up-down orientation. In some embodiments, the vertical alignment is offset from perpendicular to the plane of travel by about 0.1°, about 0.2°, about 0.3°, about 0.4°, about 0.5°, about 0.6°, about 0.7°, about 0.8°, about 0.9°, about 1.0°, about 1.25°, about 1.5°, about 1.75°, about 2.0°, about 2.25°, about 2.5°, about 2.75°, about 3.0°, about 3.5°, about 4.0°, about 4.5°, or about 5.0°.

In an embodiment, both the first cutter assembly 20 and the second cutter assembly 30 include a pivot component 100 for independently adjusting alignment of the respective cutter heads (22, 32).

In an embodiment, the pivot component 100 includes an upper part 102 and a lower part 104. The upper part 102 and lower part 104 may be of any suitable configuration to allow pivotable movement therebetween. In an embodiment, the upper part 102 is shaped like a spherical plate having a curved bottom that rests within a cupped portion of the lower part 104 (e.g., a spherical plate atop a spherical cup).

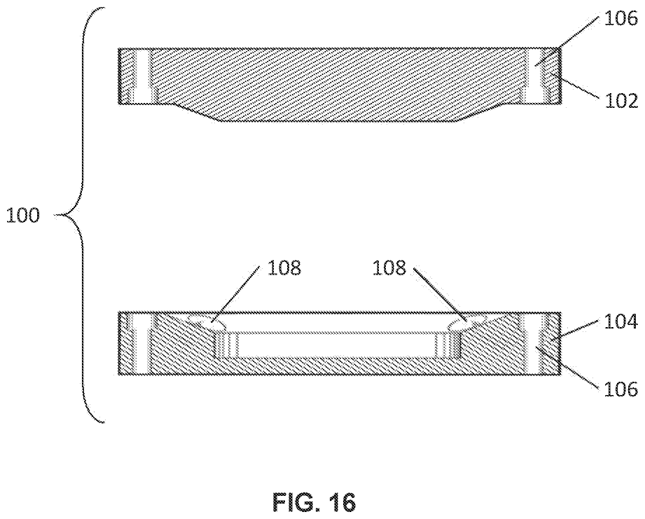

With reference to FIG. 16, a further embodiment of a pivot component 100 is shown in which the upper part 102 and a lower part 104 each include a threaded bore 106 for receiving a bolt (not shown) to affix the upper part 102 to the cutter assembly (20, 30) and the lower part 104 to the slide or rail system 12 or a base that is slidably mounted to the rail or slide system 12. Further, one or more convex caps 108 (e.g., protruding circular bumps) are provided on the shoulder of the cupped surface of the lower part 104 to facilitate the ease of pivotable adjustments.

Further suitable pivot components 100 for use in association with the guide dresser of the present disclosure may include a two-part pivotable block component, for example as disclosed in U.S. Pat. Nos. 9,199,320 and 10,267,450.

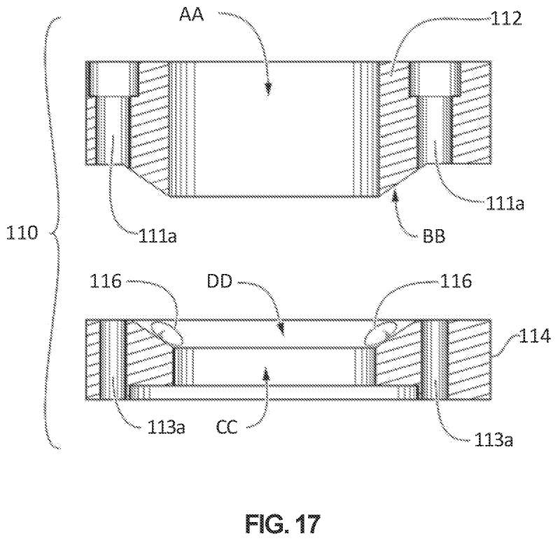

An exemplary two-part pivotable block component 110 that may be used in association with the cutter assembly (20, 30) of the present disclosure is shown in FIG. 17. The two-part block component 110 includes an upper block 112 and a lower block 114. The upper block 112 may be provided with threaded bores 111a aligned with bores 113a for receiving and engaging aligning bolts (not shown). Alternatively, the lower block may be provided with threaded bores for engaging aligning bolts inserted through bores provided therefore in the upper block.

The upper block 112 may be provided with a bore AA for receiving therethrough a post extending downward from the cutter assembly (20, 30). The upper block 112 has an outwardly inclined downward extending shoulder BB in the form of a frustoconical surface having a plane relative to a horizontal plane, selected from a range of between about 5° to about 75°, and more particularly between about 10° to about 45°. An exemplary suitable plane is about 10°, about 12.5°, about 15°, about 17.5°, about 20°, about 22.5°, about 25°, about 27.5°, about 30°, about 32.5°, about 35°, about 37.5°, about 40°, about 42.5°, about 45°, about 47.5°, or about 50°.

The lower block 114 may be provided with a bore CC that has a larger diameter than bore AA provided in upper block 112. It is preferable that the diameter of bore CC provides a gap between the lower block 114 and a post extending therethrough, for example a gap of about 2 mm, about 3 mm, about 4 mm, about 5 mm, about 6 mm, about 7 mm, about 8 mm, about 9 mm, about 10 mm, or anywhere therebetween. The lower block 114 has an inwardly receding inclined shoulder DD in the form of a frustoconical surface having a plane relative to the plane of the outwardly extending shoulder BB, that is offset to the plane of AA for example by about 0.25°, about 0.50°, about 0.75°, about 1.0°, about 1.25°, about 1.5°, about 1.75°, about 2.0°, about 2.25°, about 2.5°, about 2.75°, about 3.0°, about 3.5°, about 4.0°, about 4.5°, or about 5.0°. The offset in the planes between the outwardly inclined shoulder BB of upper block 112 and the inwardly receding inclined shoulder DD of lower block 114 enables precise pivotable adjustments of the cutter assembly (20, 30) in a three-dimensional space, and thereby alignment of the cutter head (22, 32). If so desired, one or more convex caps 116 may be provided on the upper shoulder BB or the lower shoulder DD (as shown in FIG. 17) to facilitate the ease of pivotable adjustments of the two-part block component 110. It is optional and within the scope of the present disclosure to provide the lower block 114 with an outwardly inclined upward extending shoulder, and to provide the upper block 112 with the inwardly receding inclined shoulder.

In other embodiments, the present disclosure relates to a method for milling a saw guide, the method including: providing a saw guide 50 to a guide mount assembly 40 of a guide dresser 10; moving the saw guide 50 to an upper position; moving a first cutter assembly 20 and a second cutter assembly 30 towards each other on a rail or slide system 12 from an open position to a closed position; moving the saw guide 50 down to a lower position between a first rotatable cutter head 22 of the first cutter assembly 20 and a second rotatable cutter head 32 of the second cutter assembly 30, thereby causing the first cutter head 22 of the first cutter assembly 20 and the second cutter head 32 of the second cutter assembly 30 to engage against opposing sides of the saw guide 50; and milling or machining the saw guide 50.

In an embodiment, the step of providing a saw guide 50 to a guide mount assembly 40 of a guide dresser 10 is performed when the guide mount assembly 40 is configured to receive the saw guide in the lower position, such as shown in FIG. 1. However, the saw guide 50 may also be received onto the guide mount assembly 40 in a different position, including the upper position. If the saw guide 50 is mounted to the guide mount assembly 40 in the upper position, then the step of moving the saw guide 50 to the upper position is not needed.

In an embodiment, the step of providing a saw guide 50 to a guide mount assembly 40 of a guide dresser 10 is performed when the first and second cutter assemblies (20, 30) are in the open position. However, the first and second cutter assemblies (20, 30) may be at any position along the slide and rail system 12 when the saw guide 50 is provided to the guide dresser 10.

Without limitation, in typical operation after the saw guide 50 is mounted to the guide mount assembly 40, the saw guide 50 is moved to the upper position. In such embodiments, movement of the saw guide 50 to the upper position may occur prior to or at the same time as movement of the first and second cutter assemblies (20, 30) to the closed position. In a particular embodiment, detection of the saw guide 50 in the upper position by a proximity switch 47 causes activation and movement of the first and second cutter assemblies (20, 30) to the closed position.

Without limitation, in typical operation after the first and second cutter assemblies (20, 30) are in the closed position, the saw guide 50 is lowered from the upper position to the lower position. In the lower position, the saw guide 50 is position between and engaged by the first and second rotatable cutter heads (22, 32) to mill the saw guide 50. The step of milling or machining the saw guide 50 may or may not include further movement of the first and second cutter assemblies (20, 30) in either direction along the rail and slide system 12. Likewise, milling or machining the saw guide 50 may or may included adjustments to the position of the saw guide 50.

As the skilled person will appreciate, numerous adjustments to the order of operation of the method steps may be made for milling the saw guide 50. In addition, various steps may be repeated.

In an embodiment of the methods herein, the position of each cutter assembly (20, 30) on the rail or slide system 12 is controlled with a programmable controller, such as a programmable logic controller (PLC) and/or computer numerical control (CNC) programming. In an embodiment, the rail or slide system 12 includes its own independent motor to drive movement of each cutter assembly (20, 30) on the rail or slide system 12. The motor may, for example, be a servo motor. In an embodiment, the rail or slide system 12 includes servo motor-controlled ball screw and linear bearings for programmable and repeatable positioning of each cutter assembly (20, 30). The rpm and spherical alignment of the cutter heads (22, 32) may also be similarly controlled by automated processes.

In an embodiment of the methods disclosed herein, milling of a saw guide 50 using the movable cutter assemblies (20, 30) and the cutter heads (22, 32) of the present disclosure is capable of cutting to high tolerances (e.g., cut to within 0.0005″).

In an embodiment of the methods herein, the position of the saw guide 50 as between the upper position and the lower position is controlled with a programmable controller, such as a programmable logic controller (PLC) and/or computer numerical control (CNC) programming. In an embodiment, a saw guide rail or assembly 44 includes a saw guide carriage 48 for receiving the saw guide 50. The saw guide carriage 48 is, for example, slidably mounted on the saw guide rail or slide assembly 44. In an embodiment, the saw guide rail or slide assembly 44 includes its own independent motor to drive movement of the saw guide 50 on the saw guide rail or slide assembly 44. The motor 46 may, for example, be a servo motor. In an embodiment, the saw guide rail or slide assembly 44 includes servo motor-controlled ball screw and linear bearings for programmable and repeatable positioning of the saw guide. In an embodiment, the saw guide rail or slide assembly 44 includes a proximity switch 46 to detect the position of the saw guide 50. In the methods herein, detection of the received saw guide 50 in an upper position by the proximity switch may, for example, activate movement of both the first and second cutter assemblies (20, 30) towards each other on the rail or slide system 12.

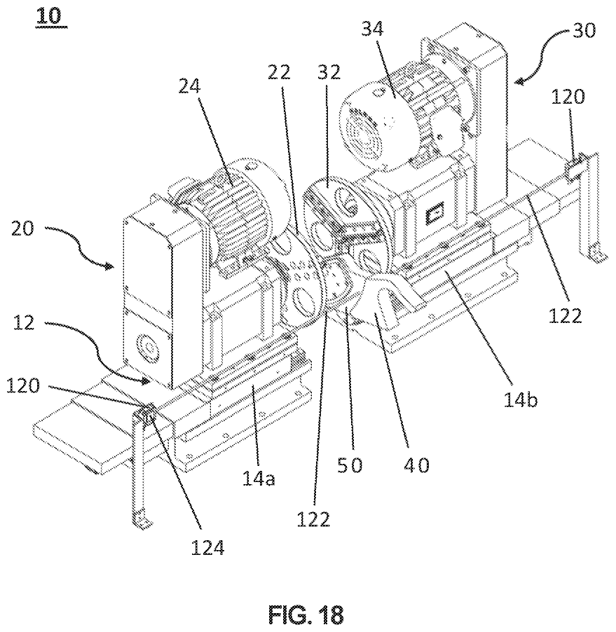

In some embodiments of the guide dressers herein, milling or machining of the saw guide is an automated operation. Referring to FIG. 18, the guide dresser of the present disclosure may include one or more laser range finders 120. The laser range finders 120 may be positioned and aligned in any suitable location on the guide dresser 10 to take a measurement of the saw guide 50 when it is positioned in the guide mount assembly 40. As used herein, the term “measurement” is intended to mean a measure of distance, angle, or any combination thereof. The laser range finders 120 function to allow the guide dresser 10 to automatically identify which saw guide 50 (e.g., type, size, material, etc.) has been inserted into the guide dresser 10. In some embodiments, the laser range finder 120 may include additional analysis capabilities to obtain information regarding the saw guide 50. For example, the laser range finder 120 may include an optical scanner or imaging device that is capable of reading information displayed on the side of the saw guide 50, such as a bar code or QR code.

In the embodiment shown in FIG. 18, the guide dresser includes two of the laser range finders 120. A first laser range finder 120 is positioned on the same side of the guide dresser 10 as the first cutter assembly 20 and a second laser range finder 120 is positioned on the same side of the guide dresser 10 as the second cutter assembly 30. Each laser range finder 120 directs its beam 122 in the direction of the saw guide 50 to take a measurement. In the embodiment of FIG. 18, each of the laser range finders 120 is directed along the same horizontal plane as the other and positioned to take a measurement along the path of slidable movement of the respective cutter assembly (20, 30). As will be appreciated, this is an exemplary positioning of the laser range finders 120. In other embodiments, one or each of the laser range finders 120 may be at a different horizontal plane and/or aligned to measure the saw guide 50 from a different angle. In addition, there may be more than one laser range finder 120 directing its beam 122 to a particular side of the saw guide 50, such as one on a horizontal plane, one on an angle, one pointed at a different area or feature of the saw guide 50, or any combination thereof.

The guide dresser 10 is capable of interpreting the measurement from each laser range finder 120 to automatically control the movement of one or both of the cutter assemblies (20, 30) and the saw guide 50 to enable the cutter heads (22, 32) to properly and accurately mill the saw guide 50, including by slidable movement along the rail or slide system 12 and/or pivotal movement about the pivotal component. In some embodiments, subsequent to obtaining measurements from the laser range finders 120 the entire milling or machining process is automated. In other embodiments, there may be steps that are not automated.

In an embodiment, during an initial setup phase each saw guide 50 may be mounted in the guide dresser 10 and a measurement from each side of the guide taken using the laser range finders 120. The measurement may be registered and stored in a database containing all other pertinent information about each saw guide (e.g., within PLC software), including for example laser range data, target size, number of babbitt pads, and orientation of babbitt pads (e.g., right or left). The initial setup phase may only be required once for each different type of saw guide 50 to create a stored database of saw guides 50, and afterwards whenever the guide dresser 10 identifies a saw guide 50 of that type using the laser range finders 120, automated operation can be performed without requiring further setup procedures.

For example, when in operation, a user may insert a saw guide 50 into the guide dresser 10 and select a protocol to identify the saw guide 50 (e.g., from a touchscreen). This command triggers the laser range finders 120 to take a measurement of the current saw guide 50 and compare the result (e.g., measurements) with the stored database of saw guides 50. Once the saw guide 50 is identified, its identity may be confirmed by the user, or this step of confirmation may not be required. The guide dresser 10 uses the identity of the saw guide 50 to move the cutter assemblies (one or both; 20, 30) from the open position to the closed position and/or the saw guide 50 between the upper position and the lower position to cut the saw guide 50. This operation may be automatic, in whole or in part, based on results of the measurement of the laser range finders 120.

In some embodiments, an initial setup phase is not required and the automated operation of cutting the saw guides 50 can be performed without having stored information on the saw guide 50, based simply on the measurements taken by the laser range finders 120.

Automated operation of the cutter assemblies (20, 30) and/or the position of the saw guide 50 based on the measurements from the laser range finders 120 can involve one or more functionalities to ensure proper and accurate cutting of the saw guide 50. These functionalities may be achieved by controlling slidable movement of the cutter assemblies (20, 30) along the rail or slide system 12; pivotal movement about the pivotal component; and/or adjustable movement of the saw guide 50 by the guide mount assembly 40 between the upper and lower positions. These functionalities include, without limitation: ensuring the saw guide 50 is machined to the correct target size; identifying the number of babbitt pads of the saw guide 50 and cutting appropriately, identifying which side of the saw guide 50 the babbitt pads are on (if on only one side) and cutting appropriately, determining if the saw guide 50 is at an angle and making pivotal adjustments to the cutter heads (22, 32) for appropriate cutting, or any combination thereof.

In an embodiment, and as shown in FIG. 18, the guide dresser may include a data analyzer 124. The data analyzer 124 may be internal to or in a combined unit with one or more of the laser range finders 120 or may be an entirely separate unit on the guide dresser 10. In other embodiments, the data analyzer 124 may be located remotely from the guide dresser 10 and may communicate with the laser range finders 120 either by wired or wireless means. When equipped, the data analyzer 124 can provide various functions such as receiving the measurements from the laser range finders 120, identifying the type of saw guide 50 from the measurements, such as by comparing the measurements to the stored data, controlling the automated operation of the guide dresser 10, or any combination thereof. In order to identify the type of saw guide 50 from the measurements, the data analyzer may include or communicate with a database containing the stored information about one or more different types of the saw guide 50. This database may contain any number or quantity of stored pieces of information relating to saw guides 50, including without limitation laser range data, milling target size, number of babbitt pads, orientation of the babbitt pads, milling parameters, and milling thresholds. The data analyzer 124 may include a programmable logic controller (PLC).

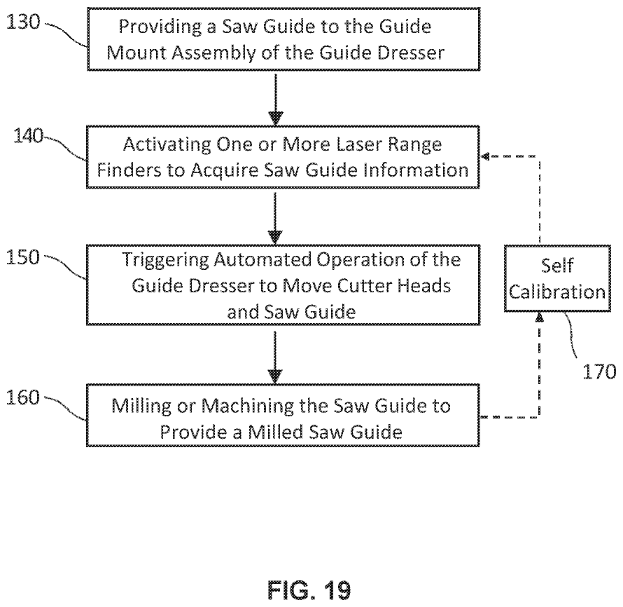

In relation to embodiments in which the guide dresser 10 includes one or more laser range finders 120, as shown in FIG. 19 the present disclosure further provides a method for automated milling of a saw guide 50, the method including: providing a saw guide 50 to the guide mount assembly 40 of the guide dresser 10 (130); activating the one or more laser range finders 120 to acquire measurements of the saw guide 50 (140); triggering automated operation of the guide dresser 10 to move the saw guide 50 on the guide mount assembly 40 and/or the first cutter assembly 20 and the second cutter assembly 30 on the rail or slide system 12 to engage the first cutter head 22 of the first cutter assembly 20 and the second cutter head 32 of the second cutter assembly 30 against opposing sides of the saw guide 50 (150); and milling or machining the saw guide 50 to provide a milled saw guide 50 (160).

In an embodiment, the step of activating the one or more laser range finders 120 to acquire measurements of the saw guide 50 includes two laser range finders 120 each acquiring the measurement from an opposite side of the saw guide 50. As discussed elsewhere herein, the laser range finders 120 may be positioned at any suitable position and at any trajectory to the saw guide 50. In an embodiment, the two laser range finders 120 are on the same horizontal plane and the beam 122 follows the path along the rail or slide system 12.

In an embodiment, the step of triggering automated operation of the guide dresser 10 includes a step of comparing the measurements acquired by the one or more laser range finders 120 to stored information relating to laser range data, milling target size, number of babbitt pads, orientation of the babbitt pads, milling parameters, and milling thresholds for one or more different types of saw guides. As discussed elsewhere herein, the stored information may be based on an initial setup phase. Thus, in a further embodiment, the methods herein include a further step of performing an initial setup phase or initialization procedure to correspond measurements for particular saw guides 50 to information relating to that type of saw guide 50. The initialization procedure may include mounting different saw guides 50 to the guide mount assembly 40, obtaining measurements from each side for each of the saw guides 50 to provide the laser range data for each saw guide 50; correlating the measurements to a set of parameters for each saw guide 50 to provide a correlated dataset, and storing the correlated dataset as the stored information.

In an embodiment, the step of triggering automated operation of the guide dresser 10 includes a step of activating automated operation of the guide dresser 10 based on an identity of the saw guide 50 determined by the step of comparing the measurements acquired by the one or more laser range finders 120 to the stored information. In an embodiment, a programmable logic controller (PLC) uses the stored information to ensure a correct target size of the saw guide is milled.

In an embodiment, the methods herein may further include a self-calibration procedure of measuring the milled saw guide 50; calculating the difference between a target size and a milled size; and adjusting milling parameters for subsequent operation. In an embodiment, the subsequent operation is repeating steps 150 and 160, after the measuring the milled saw guide 50 by repeating step 140.

In an embodiment of the methods herein, the entirety of the method, subsequent to providing the saw guide to the guide mount assembly (130), is automated. In other embodiments, the method is partly automated. For example, in some embodiments, after step 160 when the milled saw guide 50 is provided, the user may be prompted to manually input the measurement of the milled saw guide 50 into the guide dresser 10 (e.g., into the PLC control). The guide dresser 10 can then use that input to calculate the difference between the target size and the actual measurement and adjust accordingly for the repeated milling step, which the user may manually initiate.

Advantageously, the guide dresser 10 and methods herein allow a user to put in at random any saw guide 50 that has been registered in the guide dresser 10 and repeat the milling process without needing to recalibrate the guide dresser 50 during saw guide 50 style changes.

In other embodiments, the present disclosure relates to a kit including one or more components of the cutter heads (22, 32) described herein. For example, in an embodiment, the present disclosure relates to a kit including a circular disc 60 for use as a cutter head (22, 32), and one or more removable knife retention apparatuses 70 as disclosed herein. The kit may further include one or more knives 80 for mounting in each of the removable knife retention apparatuses 70. In another embodiment, the kit may include a circular disc 90 having two or more grooves 92 on a face thereof for use as a cutter head, and two or more cutting implements 94.

### Exemplary Embodiments

In exemplary and non-limiting embodiments, the present disclosure relates to the following:

(1) A guide dresser for milling a saw guide, the guide dresser including: a rail or slide system; a first cutter assembly slidably mounted on the rail or slide system, the first cutter assembly having a first rotatable cutter head; a second cutter assembly slidably mounted on the rail or slide system, the second cutter assembly having a second rotatable cutter head; and a guide mount assembly for receiving and adjustably moving a saw guide between an upper position and a lower position, the upper position being above the first and second rotatable cutter heads and the lower position being between the first and second rotatable cutter heads, the guide dresser being adjustable between an open position and a closed position by slidable movement of the first cutter assembly, the second cutter assembly, or both, wherein: when in the open position, both the first cutter assembly and the second cutter assembly are positioned away from the guide mount assembly on the rail system, and when in the closed position, both the first cutter assembly and the second cutter assembly are positioned proximal to the guide mount assembly on the rail system, such that both the first and second rotatable cutter heads are capable of contacting the saw guide when it is received on the guide mount assembly and is in or is moved to the lower position.

(2) The guide dresser of (1), wherein each of the first cutter assembly and the second cutter assembly include a motor to impart rotational movement to the first and second rotatable cutter head.

(3) The guide dresser of (1) or (2), wherein the first cutter assembly includes a pivot component for adjusting alignment of the first cutter head.

(4) The guide dresser of (1) or (2), wherein each of the first cutter assembly and the second cutter assembly include a pivot component for independently adjusting alignment of the first cutter head and the second cutter head.

(5) The guide dresser of (3) or (4), wherein the pivot component is a two-part pivotable block component.

(6) The guide dresser of (5), wherein the two-part pivotable block component includes an upper spherical plate and a lower spherical cup, the upper spherical plate pivotably and slidably engaged with the lower spherical cup.

(7) The guide dresser of (5), wherein the two-part pivotable block component includes: an upper block that is engaged with the first cutter assembly or the second cutter assembly; and a lower block that is slidably mounted to the rail or slide system or, alternatively, is engaged with a base that is slidably mounted to the rail or slide system, wherein the upper block has a first inclined surface in a first plane for pivotably and slidably engaging a second inclined surface in a second plane provided on the lower block, and wherein: the first inclined surface in the first plane is at an angle defined by a first angle from a horizontal plant; the second inclined surface in the second plane is at an angle defined by a second angle from the horizontal plane; and the first angle and the second angle are different angles.

(8) The guide dresser of (7), wherein the first inclined surface of the upper block is outwardly extending, and the second inclined surface of the lower block is inwardly receding.

(9) The guide dresser of (7), wherein the first inclined surface of the upper block is inwardly receding, and the second inclined surface of the lower block is outwardly extending.

(10) The guide dresser of any one of (7) to (9), wherein one or both of the first inclined surface and the second inclined surface is provided with at least one convex cap extending outward therefrom.

(11) The guide dresser of any one of (7) to (10), wherein the second inclined surface is offset from the first inclined surface by about 0.25° to about 5.0°.

(12) The guide dresser of (5), wherein the two-part pivotable block component includes: an upper block that is engaged with the first cutter assembly or the second cutter assembly; and a lower block that is slidably mounted to the rail or slide system or is engaged with a base that is slidably mounted to the rail or slide system wherein the upper block has a first frustoconical surface for pivotably engaging a second frustoconical surface provided therefor on the lower block, and wherein one or both of the first frustoconical surface and the second frustoconical surface has at least one convex cap extending outwardly therefrom for facilitating pivotable adjustment of the two-part block component.

(13) The guide dresser of (12), wherein the first frustoconical surface of the upper block is outwardly extending and the second frustoconical surface of the lower block is inwardly receding.

(14) The guide dresser of (12), wherein the first frustoconical surface of the upper block is inwardly receding and the second frustoconical surface of the lower block is outwardly extending.

(15) The guide dresser of any one of (3) to (14), wherein, when in operation and the vertical positioning of the saw guide is skewed from a vertical direction, the pivot component aligns the first and second rotatable cutter heads.

(16) The guide dresser of any one of (1) to (15), wherein the rail or slide system includes a single continuous rail or slide component having both the first cutter assembly and the second cutter assembly slidably mounted thereon.

(17) The guide dresser of any one of (1) to (15), wherein the rail or slide system includes: a first rail or slide apparatus having the first cutter assembly slidably mounted thereon; and a second rail or slide apparatus having the second cutter assembly slidably mounted thereon.

(18) The guide dresser of any one of (1) to (17), which includes a servo motor-controlled ball screw for modulating slidable movement of the first cutter assembly and the second cutter assembly along the rail or slide system.

(19) The guide dresser of any one of (1) to (18), wherein the guide mount assembly includes a mount apparatus and a saw guide rail or slide assembly interconnected to the mount apparatus and configured for receiving the saw guide.

(20) The guide dresser of (19), wherein the saw guide rail or slide assembly includes a saw guide carriage slidably mounted thereon for receiving the saw guide.

(21) The guide dresser of (19) or (20), wherein the saw guide rail or slide assembly includes a servo motor-controlled ball screw for adjustably moving the saw guide along the saw guide rail or slide assembly.

(22) The guide dresser of any one of (19) to (21), wherein the saw guide rail or slide assembly includes a proximity switch for detecting when the saw guide is in the upper position.

(23) The guide dresser of (22), wherein detection of the saw guide in the upper position activates the slidable movement of the first cutter assembly and the second cutter assembly towards each other on the rail or slide system.

(24) The guide dresser of any one of (19) to (23), wherein the saw guide rail or slide assembly is aligned for slidable movement of the saw guide between the upper position and the lower position along a fixed non-horizontal axis.

(25) The guide dresser of (24), wherein the fixed non-horizontal axis is parallel to a vertical plane defined by a horizontal axis along which slidable movement of the first and second cutter assemblies occurs.

(26) The guide dresser of any one of (19) to (25), wherein each of the upper position and lower position of the saw guide are between the first cutter assembly and the second cutter assembly.

(27) The guide dresser of (24), wherein the fixed non-horizontal axis is tilted between about 1° and about 45° degrees from parallel to a vertical plane defined by a horizontal axis along which slidable movement of the first and second cutter assemblies occurs.

(28) The guide dresser of any one of (19) to (27), wherein one or both of movement between the open position and the closed position and movement between the upper position and the lower position is independently, in whole or in part, an automatic operation.

(29) The guide dresser of (28), further including one or more laser range finders positioned and aligned to take a measurement of the saw guide when the saw guide is positioned on the guide mount assembly, wherein the automatic operation is based on results of the measurement of the one or more laser range finders.

(30) The guide dresser of any one (1) to (29), wherein in operation the saw guide is received onto the guide mount assembly in the lower position when the first and second cutter assemblies are in the open position; the saw guide is moved to the upper position, thereby activating the first and second cutter assemblies to the closed position; and the saw guide is moved downward towards the lower position once the first and second cutter assemblies are in the closed position, thereby milling the saw guide.

(31) The guide dresser of any one of (1) to (30), wherein each of the first cutter head and the second cutter head is a circular disc including one or more knives projecting from a side of the circular disc.

(32) The guide dresser of (31), wherein the circular disc includes a knife retention apparatus for holding each of the one or more knives in place.

(33) The guide dresser of (32), wherein the knife retention apparatus includes a knife holder, a knife gib, a knife gib screw, and a knife clamp.

(34) The guide dresser of any one of (31) to (33), wherein the circular disc includes three knives projecting from the side.

(35) The guide dresser of any one of (1) to (30), wherein each of the first cutter head and the second cutter head is a circular disc including two or more grooves on a side of the circular disc into which two or more cutting implements are mounted.

(36) The guide dresser of (35), wherein the two or more cutting implements are included of carbide.

(37) The guide dresser of (35) or (36), wherein the two or more cutting implements in each groove of the two or more grooves are offset from the center of the circular disc by a different distance along the radially extending wall as compared to the two or more cutting implements in the other grooves.

(38) The guide dresser of (37), wherein upon rotational movement of the circular disc, the two or more cutting implements in each groove of the two or more grooves cuts a different circular area than the two or more cutting implements in the other grooves.

(39) A method for milling a saw guide, the method including: providing a saw guide to a guide mount assembly of a guide dresser; moving the saw guide to an upper position, the upper position being above a first rotatable cutter head of a first cutter assembly and a second rotatable cutter head of a second cutter assembly; moving the first cutter assembly and the second cutter assembly towards each other on a rail or slide system from an open position to a closed position; moving the saw guide down to a lower position between the first and second rotatable cutter heads in the closed position, thereby causing the first and second rotatable cutter heads to engage the saw guide from opposing sides; and milling or machining the saw guide as it is in or passes to the lower position.

(40) The method of (39), wherein any one or more of the steps is by an automated process.

(41) The method of (40), wherein the automated process includes programmable CNC controls.

(42) The method of any of (39) to (41), wherein the first cutter assembly and the second cutter assembly are as defined in any one of (1) to (38).

(43) A cutter head, the cutter head including a circular disc and one or more removable knife retention apparatuses, each of the one or more removable knife retention apparatuses for receiving a knife.

(44) The cutter head of (43), wherein each of the one of more removable knife retention apparatuses includes a knife holder, a knife gib, a knife clamp, and one or more knife gib screws.

(45) The cutter head of (44), wherein each of the knife holder and the knife clamp are an elongate shape configured to substantially span a radius of the circular disc when mounted on the circular disc.

(46) The cutter head of (45), wherein each of the knife holder and the knife clamp include one or more mounting apertures, each of the one or more mounting apertures for receiving a pin protruding from the circular disc.

(47) The cutter head of (45) or (46), wherein the knife gib is of the elongate shape configured to substantially span the radius of the circular disc when mounted on the circular disc, and the knife gib and the knife clamp have corresponding notches for receiving a portion of the knife gib screw.

(48) The cutter head of any one of (44) to (47), wherein, when the removable knife retention apparatus is assembled on the circular disc to receive the knife, the knife is positioned between the knife holder and the knife gib to project a blade of the knife outwardly therefrom, and the knife is held in position by a force applied to the knife by the knife gib, the force exerted and maintained by the knife screw.

(49) The cutter head of any one of (43) to (48), including at least three of the one or more removable knife retention apparatuses mounted on the circular disc, each of the one or more removable knife retention apparatuses having the knife received therein.

(50) A cutter head, the cutter head including a circular disc having two or more grooves on a face thereof, each groove of the two or more grooves for receiving two or more cutting implements.

(51) The cutter head of (40), wherein each groove of the two or more grooves is an elongate shape configured to substantially span a radius of the circular disc.

(52) The cutter head of (50) or (51), including at least three of the two or more grooves.

(53) The cutter head of any one of (50) to (52), wherein, when received in the two or more grooves, each of the two or more cutting implements are substantially equally spaced from each other along a radially extending wall within each groove of the two or more grooves.

(54) The cutter head of (53), wherein, when received in the two or more grooves, the two or more cutting implements in each groove of the two or more grooves are offset from the center of the circular disc by a different distance along the radially extending wall as compared to the two or more cutting implements in the other grooves.

(55) The cutter head of (54), wherein, when in operation in a circular rotation, the two or more cutting implements in each groove of the two or more grooves cuts a different circular area than the two or more cutting implements in the other grooves.

(56) The cutter head of (55), wherein, when in operation in the circular rotation, the different circular area cut by the two or more cutting implements in each groove overlaps with a portion of the different circular area cut by the two or more cutting implements in at least one of the other grooves.

(57) The cutter head of any one of (50) to (56), wherein the two or more cutting implements are formed of carbide.

(58) The cutter head of any one of (50) to (57), wherein the two or more cutting implements are secured to the cutter head by a screw or a clamp.

(59) A guide dresser for milling a saw guide, the guide dresser including: a rail or slide system; a first cutter assembly slidably mounted on the rail or slide system, the first cutter assembly having a first rotatable cutter head; a second cutter assembly slidably mounted on the rail or slide system, the second cutter assembly having a second rotatable cutter head; a guide mount assembly for receiving and adjustably moving a saw guide between an upper position and a lower position, the upper position being above the first and second rotatable cutter heads and the lower position being between the first and second rotatable cutter heads, and one or more laser range finders positioned and aligned to take a measurement of the saw guide when the saw guide is positioned in the guide mount assembly, the guide dresser being automatically adjustable between an open position and a closed position by slidable movement of the first cutter assembly, the second cutter assembly, or both, wherein: when in the open position, both the first cutter assembly and the second cutter assembly are positioned away from the guide mount assembly on the rail system, and when in the closed position, both the first cutter assembly and the second cutter assembly are positioned proximal to the guide mount assembly on the rail system, such that both the first and second rotatable cutter heads are capable of contacting the saw guide when it is received on the guide mount assembly and is in or is moved to the lower position, wherein the slidable movement between the open position and the closed position is in whole or in part an automatic operation based on results of the measurement of the one or more laser range finders.

(60) The guide dresser of (59), wherein the slidable movement between the open position and the closed position is in whole controlled by the automatic operation.

(61) The guide dresser of (59) or (60), wherein each of the one or more laser range finders is aligned to measure the saw guide from a different angle.

(62) The guide dresser of any one of (59) to (61), wherein the one or more laser range finders include: a first laser range finder positioned on the same side of the guide dresser as the first cutter assembly, and positioned and aligned to take the measurement along the path of slidable movement of the first cutter assembly; and a second laser range finder positioned on the same side of the guide dresser as the second cutter assembly, and positioned and aligned to take the measurement along the path of slidable movement of the second cutter assembly.

(63) The guide dresser of any one of (59) to (62), further including a data analyzer for receiving the measurement and controlling the automatic operation.

(64) The guide dresser of (63), wherein the data analyzer identifies the type of the saw guide from the measurement of the one or more laser range finders.

(65) The guide dresser of (63) or (64), wherein the data analyzer includes or communicates with a database containing stored information about one or more different types of the saw guide.

(66) The guide dresser of (65), wherein the database includes stored information relating to laser range data, milling target size, number of babbitt pads, orientation of the babbitt pads, milling parameters, and milling thresholds for each of the one or more different types of the saw guide.

(67) The guide dresser of any one of (59) to (66), which includes a programmable logic controller (PLC).

(68) The guide dresser of any one of (59) to (67), wherein the automatic operation includes one of or any combination thereof (i) slidable movement of the first cutter assembly and the second cutter assembly on the rail or slide system, (ii) pivotal movement of the first cutter assembly and the second cutter assembly about a pivot component, and (iii) slidable movement of the saw guide on the guide mount assembly.

(69) The guide dresser of (68), wherein the pivotal component is a two-part pivotable block component including an upper spherical plate and a lower spherical cup, the upper spherical plate pivotably and slidably engaged with the lower spherical cup.

(70) The guide dresser of (68) or (69), wherein, when in operation and the vertical positioning of the saw guide is skewed from a vertical direction, the pivot component automatically aligns the first and second rotatable cutter heads based on the measurement from the one or more laser range finders.

(71) A method for automated milling of a saw guide, the method including: providing a saw guide to the guide mount assembly of the guide dresser of any one of (59) to (70); activating the one or more laser range finders to acquire measurements of the saw guide; triggering automated operation of the guide dresser to move the saw guide on the guide mount assembly and the first cutter assembly and the second cutter assembly on the rail or slide system to engage the first cutter head of the first cutter assembly and the second cutter head of the second cutter assembly against opposing sides of the saw guide; and milling or machining the saw guide to provide a milled saw guide.

(72) The method of (71), wherein the step of activating the one or more laser range finders to acquire measurements of the saw guide includes two laser range finders each acquiring the measurement from an opposite side of the saw guide.

(73) The method of (71) or (72), wherein the step of triggering automated operation of the guide dresser includes a step of comparing the measurements acquired by the one or more laser range finders to stored information relating to laser range data, milling target size, number of babbitt pads, orientation of the babbitt pads, milling parameters, and milling thresholds for one or more different types of saw guides.

(74) The method of (73), wherein the stored information was previously obtained and stored in a database during an initialization procedure, the initialization procedure including: mounting different saw guides to the guide mount assembly, obtaining measurements from each side for each of the saw guides to provide the laser range data for each saw guide; correlating the measurements to a set of parameters for each saw guide to provide a correlated dataset, and storing the correlated dataset as the stored information.

(75) The method of (73) or (74), wherein the step of triggering automated operation of the guide dresser includes a step of activating automated operation of the guide dresser based on an identity of the saw guide determined by the step of comparing the measurements acquired by the one or more laser range finders to the stored information.

(76) The method of any one of (73) to (75), wherein a programmable logic controller (PLC) uses the stored information to ensure a correct target size of the saw guide is milled.

(77) The method of any one of (71) to (76), further including a self-calibration procedure of measuring the milled saw guide; calculating the difference between a target size and a milled size; and adjusting milling parameters for subsequent operation.

(78) The method of any one of (71) to (77), wherein the entirety of the method, subsequent to providing the saw guide to the guide mount assembly, is automated.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design shown herein, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. A guide dresser for milling a saw guide, the guide dresser comprising:
a rail or slide system;
a first cutter assembly slidably mounted on the rail or slide system, the first cutter assembly having a first rotatable cutter head;
a second cutter assembly slidably mounted on the rail or slide system, the second cutter assembly having a second rotatable cutter head; and
a guide mount assembly for receiving and adjustably moving a saw guide between an upper position and a lower position, the upper position being above the first and second rotatable cutter heads and the lower position being between the first and second rotatable cutter heads, wherein the guide dresser is adjustable between an open position and a closed position by slidable movement of the first cutter assembly, the second cutter assembly, or both, wherein both the first cutter assembly and the second cutter assembly are positioned away from the guide mount assembly on the rail system when in the open position, and wherein both the first cutter assembly and the second cutter assembly are positioned proximal to the guide mount assembly on the rail system when in the closed position, such that both the first and second rotatable cutter heads are capable of contacting the saw guide when it is received on the guide mount assembly and is in or is moved to the lower position.

2. The guide dresser of claim 1, wherein the guide mount assembly comprises a mount apparatus and a saw guide rail or slide assembly interconnected to the mount apparatus and configured for receiving the saw guide.

3. The guide dresser of claim 2, wherein the saw guide rail or slide assembly comprises a saw guide carriage slidably mounted thereon for receiving the saw guide.

4. The guide dresser of claim 2, wherein the saw guide rail or slide assembly comprises a servo motor controlled ball screw for adjustably moving the saw guide along the saw guide rail or slide assembly.

5. The guide dresser of claim 2, wherein the saw guide rail or slide assembly comprises a proximity switch for detecting when the saw guide is in the upper position.

6. The guide dresser of claim 5, wherein detection of the saw guide in the upper position activates the slidable movement of the first cutter assembly and the second cutter assembly towards each other on the rail or slide system.

7. The guide dresser of claim 2, wherein the saw guide rail or slide assembly is aligned for slidable movement of the saw guide between the upper position and the lower position along a fixed non-horizontal axis.

8. The guide dresser of claim 7, wherein the fixed non-horizontal axis is parallel to a vertical plane defined by a horizontal axis along which slidable movement of the first and second cutter assemblies occurs.

9. The guide dresser of claim 1, wherein each of the upper position and lower position of the saw guide are between the first cutter assembly and the second cutter assembly.

10. The guide dresser of claim 7, wherein the fixed non-horizontal axis is tilted between about 1° and about 45° degrees from parallel to a vertical plane defined by a horizontal axis along which slidable movement of the first and second cutter assemblies occurs.

11. The guide dresser of claim 1, wherein one or both of movement between the open position and the closed position and movement between the upper position and the lower position is independently, in whole or in part, an automatic operation.

12. The guide dresser of claim 11, further comprising one or more laser range finders positioned and aligned to take a measurement of the saw guide when the saw guide is positioned on the guide mount assembly, wherein the automatic operation is based on results of the measurement of the one or more laser range finders.

13. The guide dresser of claim 1, wherein each of the first cutter assembly and the second cutter assembly comprise a pivot component for independently adjusting alignment of the first rotatable cutter head and the second rotatable cutter head.

14. The guide dresser of claim 13, wherein, when in operation if a vertical positioning of the saw guide is skewed from a vertical direction, the pivot component aligns the first and second rotatable cutter heads.

15. The guide dresser of claim 1, wherein the rail or slide system comprises a single continuous rail or slide component having both the first cutter assembly and the second cutter assembly slidably mounted thereon.

16. The guide dresser of claim 1, wherein the rail or slide system comprises a first rail or slide apparatus having the first cutter assembly slidably mounted thereon and a second rail or slide apparatus having the second cutter assembly slidably mounted thereon.

17. The guide dresser of claim 1, wherein in operation:
the saw guide is received onto the guide mount assembly in the lower position when the first and second cutter assemblies are in the open position;
the saw guide is moved to the upper position, thereby activating the first and second cutter assemblies to the closed position; and
the saw guide is moved downward towards the lower position once the first and second cutter assemblies are in the closed position, thereby milling the saw guide.

18. A method for milling a saw guide, the method comprising:
(a) providing a saw guide to a guide mount assembly of a guide dresser;
(b) moving the saw guide to an upper position, the upper position being above a first rotatable cutter head of a first cutter assembly and a second rotatable cutter head of a second cutter assembly;
(c) moving the first cutter assembly and the second cutter assembly towards each other on a rail or slide system from an open position to a closed position;
(d) moving the saw guide down to a lower position between the first and second rotatable cutter heads in the closed position, thereby causing the first and second rotatable cutter heads to engage the saw guide from opposing sides; and
(e) milling or machining the saw guide as it is in or passes to the lower position.

19. The method of claim 18, wherein any one or more of steps (b) to (e) is by an automated process.

20. The method of claim 19, wherein the automated process comprises programmable CNC controls.
